(19) United States
(12) Patent Application Publication
(10) Pub. No.: US 2009/0257460 A1
(43) Pub. Date: Oct. 15, 2009

(54) EXTERNAL RESONATOR VARIABLE WAVELENGTH LASER AND ITS PACKAGING METHOD

(75) Inventors: Kenji Mizutani, Tokyo (JP); Jan De Merli, Tokyo (JP); Koji Kudo, Tokyo (JP); Kenji Sato, Tokyo (JP); Shinya Sudo, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 11/995,554

(22) PCT Filed: Jul. 13, 2006
(86) PCT No.: PCT/JP2006/313999

§ 371 Date: Jul. 16, 2008

(30) Foreign Application Priority Data
Jul. 13, 2005 (JP) 2005-204195

(51) Int. Cl. H01S 3/10; H01S 3/00

(52) U.S. Cl. 372/20; 359/344

(57) ABSTRACT

The reflectance of a semiconductor optical amplifier (1) on the side where an external cavity is formed is 0.1% at most. The finesse value obtained by dividing the period of the transmission characteristic of the wavelength selection filter (3) by the half value width of the transmission characteristic is 4 or more and 25 or less. Even when the reflectance of a cavity side end face (1bb) of the semiconductor optical amplifier (1) is about 0.1%, a wavelength accuracy of ±1.5 GHz can be achieved by setting the finesse to 4 or more. In addition, a wavelength accuracy of about ±0.5 GHz can be achieved by setting the finesse to 8 or more. In order to suppress insertion loss, it is preferable to set the finesse of the FP etalon to 25 or less. This makes it possible to implement an external cavity wavelength tunable laser with high wavelength accuracy.

### TECHNICAL FIELD

The present invention relates to an external cavity wavelength tunable laser having high wavelength accuracy and its implementation method.

### BACKGROUND ART

Recently, with the rapid proliferation of the Internet, there has been a demand for a further increase in communication traffic. Under the circumstance, the transmission rate per unit channel in a system has increased as well as the number of channels based on wavelength division multiplexing (WDM).

In such a wavelength division multiplexing system, importance is placed on a laser which has high single mode stability at a specific frequency (to be referred to as an “ITU grid” hereinafter) standardized by ITU (International Telecommunications Union). The ITU grid interval tends to decrease from 100 GHz to 50 GHz. As the frequency interval decreases in this manner, it is necessary to keep the laser oscillation frequency constant with high accuracy. In general, the laser needs to have an optical power characteristic with a high frequency accuracy within about ±5% relative to the ITU grid interval. When the ITU grid interval is 50 GHz, the laser preferably has a frequency accuracy within about ±2.5 GHz. This is because it is also necessary to consider wavelength fluctuations with time. As an initial characteristic, it is more preferable to achieve a frequency accuracy within about ±1.5 GHz.

As a wavelength tunable laser which meets such a requirement, an external cavity wavelength tunable laser using a semiconductor optical amplifier like that disclosed in reference 1 (Japanese Patent Laid-Open No. 2004-356504) is available. This laser allows the use of optical elements having functions which are difficult to be integrated in a semiconductor laser. Using, in particular, a wavelength selection filter having a periodic frequency characteristic and a wavelength tunable filter having a wavelength tunable range of 4 THz or more makes it possible to easily implement an external cavity wavelength tunable laser having high single mode stability in a broadband.

In addition, an optical power characteristic with high frequency accuracy can be expected by matching the periodic transmission band of a wavelength selection filter and its period (a free spectral range to be referred to as an “FSR” hereinafter) with a specific frequency and its period which are standardized by the ITU grid specifications at the time of assembly of a laser.

The exit side end face of the above semiconductor optical amplifier functions as an output coupler, from which part of a specific amount of light circulating within the cavity is extracted. For this reason, in some cases, a coating is applied to the exit side end face so as to obtain a reflectance for the optimization of performance. On the other hand, the reflectance of the cavity side end face is reduced to 0.01 to 0.1% by forming an AR (Anti Reflection) coat on the end face, introducing a window structure to the end face, or forming the end face into an oblique end face. It is technically difficult to further reduce the reflectance.

For this reason, as disclosed in reference 1, the intracavity etalon formed by two surfaces within the external cavity affects the laser performance. This is because, since a reduction in the reflectance of the cavity side end face of the semiconductor optical amplifier is not sufficient, even though the reflectance of the end face is reduced, intracavity etalons are respectively formed between the two end faces of the semiconductor optical amplifier and between an end face of the semiconductor optical amplifier and an external reflection mirror.

In particular, a wavelength selection filter or a wavelength tunable filter is placed in the cavity formed by the cavity side end face of the semiconductor optical amplifier and the external reflection mirror. As an intracavity etalon is formed, the filter characteristic deteriorates. As a result, the actual laser oscillation frequency shifts from the ITU grid. For this reason, when a Fabry-Perot solid etalon (to be referred to as an “FP etalon” hereinafter) with a finesse of 3 used for a conventional wavelength locker was used, it was difficult to achieve a high frequency accuracy of about ±1.5 GHz or less with respect to the ITU grid.

Such a laser will be described in detail below by taking reference 2 (Japanese Patent Laid-Open No. 2003-208218) previously filed by the present applicant as an example with reference to the accompanying drawings.

As shown in FIG. 15, the external cavity wavelength tunable laser in reference 2 comprises a semiconductor optical amplifier 101, collimating lenses 102a and 102b, a wavelength selection filter 103 having a periodic frequency characteristic, a wavelength tunable filter 104, and an external reflection mirror 105.

The operation principle of the wavelength selection filter with this arrangement will be described with reference to FIG. 12. First of all, light exiting from a gain area 101a contains many Fabry-Perot modes 108 dependent on the length of an external cavity 106. Of these modes, only a plurality of modes which coincide with the period of the wavelength selection filter 103 (a transmission band 9 of the wavelength selection filter in FIG. 12) are selected and made to pass through the wavelength selection filter 103. The wavelength tunable filter 104 (a transmission band 10 of the wavelength tunable filter in FIG. 12) selects only one of the plurality of modes.

The external cavity wavelength tunable laser including the wavelength selection filter 103 performs laser oscillation a only in the transmission band of the wavelength selection filter 103 but does not perform laser oscillation a at any intermediate frequency. Therefore, mounting the wavelength selection filter 103 so as to match the transmission band 9 with all desired frequency grids 11 determined by ITU or the like within the wavelength tunable range makes it possible to achieve laser oscillation a near the ITU grid 11. If an ITU grid interval 12 is 50 GHz, it is necessary to suppress the wavelength accuracy within about t1.5 GHz. In general, the transmission band of a wavelength selection filter can suppress a shift from the ITU grid within about +0.1 GHz throughout a frequency range of 4 THz.

The reflectance of a cavity side end face 101bb of the semiconductor optical amplifier 101 is reduced to 0.01% to 0.1% owing to the formation of an AR coat or inclined end face. However, since the reduction in reflectance is not sufficient, at least intracavity etalons 107b and 107a are respectively formed between the two end faces of the semiconductor optical amplifier 101 and between the end face 101bb of the semiconductor optical amplifier 101 and the external reflection mirror 105. The intracavity etalon 107a between the cavity side end face 101bb of the semiconductor optical amplifier 101 and the external reflection mirror 105, in particular, degrades the filter characteristic of the wavelength selection filter 103 because high-frequency components from the intracavity etalon 107a are added to the periodic frequency characteristic of the wavelength selection filter 103. FIG. 13 is a schematic view showing the frequency characteristic of the wavelength selection filter 103 which is degraded by the intracavity etalon 107a when the FSR of the wavelength selection filter 103 is 50 GHz. Referring to FIG. 13, the transmission peak of the wavelength selection filter shifts from the ITU grid. In general, laser oscillation occurs at the maximum transmission peak wavelength of the wavelength selection filter. As described above, the intracavity etalon 107b becomes a main factor that causes the laser oscillation wavelength to shift from the ITU grid. It is therefore necessary to suppress the shift due to the influence of the intracavity etalon 107a within about ±1.5 GHz.

In addition, when a wavelength selection filter is actually mounted, it is difficult to match the periodic transmission band of the wavelength selection filter with the ITU grid in a wide wavelength range of 4 THz or more. FIG. 14 is a flowchart showing an example of a mounting method including “(1) Temporary Placement of FP Etalon”, “(2) Angle Adjustment of FP Etalon”, “(3) Check on FSR”, “(4) Fixation of Etalon”, and “(5) Fine Adjustment by Temperature Adjustment and the Like” in the use of an FP etalon equivalent to an FSR accuracy of about ±0.04 GHz which is used in a conventional wavelength locker. The respective processes will be described in the order of steps with reference to FIG. 14.

### (1) Temporary Placement of FP Etalon

First of all, the FP etalon is temporarily placed (step S11).

The angle defined by a normal line on the etalon surface and the axis of the external cavity at this time is set to, for example, 0° (vertical incidence condition).

### (2) Angle Adjustment of FP Etalon

Attention is given to one ITU grid in the wavelength tunable range to match the ITU grid channel with the transmission band of the FP etalon (step S12).

If no external cavity is formed, since laser oscillation a does not occur, it is difficult to check the frequencies of one transmission band of the FP etalon. However, it is possible to check matching between the ITU grid channel and the transmission band of the FP etalon by checking transmitted light with a spectrum analyzer.

### (3) Check on FSR

The FSR of the FP etalon is then checked by checking the frequencies of the etalon transmission band within the wavelength tunable range (step S13)

If a shift between the ITU grid interval and the FSR of the FP etalon is checked at this time (step S13: NO), the process returns to “(2) Angle Adjustment of FP Etalon”.

### (4) Fixation of Etalon

After the FSR of the FP etalon is matched with the ITU grid interval (step S13: YES), the FP etalon is fixed (step S14).

### (5) Fine Adjustment by Temperature Adjustment and the Like

The ITU grid is matched with an absolute frequency of the FP etalon transmission band by finely adjusting the shift between them (step S15).

That is, with a conventionally used etalon, this FSR checking operation must be performed a plurality of number of times due to variations in the accuracy of the etalon.

Consider a case in which a laser with an ITU grid interval of 50 GHz is implemented by using an etalon with an FSR of 49.96 about ±0.04 GHz as an FP etalon. The FP etalon allows FSR adjustment based on a temperature or incident angle, and but suffers a greater change in the absolute frequency of the transmission band of the FP etalon. If the FSR is 49.92 GHz, it is necessary to adjust the FSR to increase it by 0.08 GHz in order to set the FSR to 50 GHz. However, in the case of a wavelength near 1,550 nm, the transmission band of the FP etalon changes by 300 GHz at the maximum. That is, it is necessary to check the FSR six times at the maximum as the ITU grid interval matches with the transmission band of the FP etalon (˜300 GHz/50 GHz). The differences between the FSRs in the six checks are about 0.01 GHz at most. In consideration of a wide frequency range of 4 THz or more, such differences will lead to a great deterioration in frequency accuracy.

As described above, the conventional etalon mounting technique requires more complicated operation and a longer period of time because of the shift between the ITU grid interval and the FSR of the FP etalon.

Furthermore, since it is impossible to sufficiently check wavelength accuracy with a spectrum analyzer, the wavelength accuracy is generally about 1 GHz in a wide frequency range of 4 THz or more in real term.

The wavelength selection filter to be used includes an FP etalon and a ring resonator filter which are made of glass, quartz (silica-based material), crystal, silicon, and the like. The wavelength tunable filter to be used preferably has a wavelength tunable range of 4 THz or more and includes, for example, the acoustooptic filter disclosed in reference 3 (Japanese Patent Laid-Open No. 2003-283024), the wavelength tunable mirror having both the characteristics of a wavelength tunable filter and external reflection mirror which is disclosed in reference 4 (U.S. Pat. No. 6,215,928B1), and the ladder-type wavelength tunable filter disclosed in reference 5 (Japanese Patent Laid-Open No. 2005-45048). There is also available the filter disclosed in reference 6 (“Wavelength Tunable Laser Source composed by a PLC Ring Resonator (I)”, 2005 IEICE Spring General Conference C-3-129), which is obtained by integrating a wavelength selection filter using the Vernier effect and a wavelength tunable filter by using two ring resonator filters. When a transmission type wavelength tunable filter is used, it is necessary to prepare an external mirror and form a semiconductor optical amplifier and an external cavity.

### DISCLOSURE OF INVENTION

### Problem to be Solved by the Invention

As described above, in the conventional external cavity wavelength tunable laser, it is impossible to suppress the shift due to the influence of the intracavity etalons within about ±15 GHz. This makes it impossible to implement an external cavity wavelength tunable laser having high wavelength accuracy.

Furthermore, in mounting a wavelength selection filter, the periodic transmission band of the wavelength selection filter cannot be matched with the grid in a wide wavelength range of 4 THz or more, and the filter cannot be mounted easily within a short period of time.

It is an object of the present invention to implement an external cavity wavelength tunable laser having high wavelength accuracy.

It is another object of the present invention to mount a wavelength selection filter by a mounting method more easily and quickly than by the conventional method.

### Means of Solution to the Problem

An external cavity wavelength tunable laser according to the present invention is therefore characterized by comprising a semiconductor optical amplifier, reflection means which is placed to face one end face of the semiconductor optical amplifier to form an external cavity, a wavelength selection filter which is placed between the semiconductor optical amplifier and the reflection means and has a periodic transmission characteristic with respect to frequency, and a wavelength tunable filter which selectively transmits light with an arbitrary frequency of a plurality of frequencies selected by the wavelength selection filter, wherein a reflectance of one end face of the semiconductor optical amplifier is 0.1° at most, and a finesse value obtained by dividing a period of a transmission characteristic of the wavelength selection filter by a half value width of the transmission characteristic is not less than 4 and not more than 25.

In addition, the free spectral range accuracy of the wavelength selection filter in the external cavity wavelength tunable laser according to the present invention is within 1/8,000 of the ITU channel interval, and a mounting method for the wavelength selection filter in the external cavity wavelength tunable laser is characterized by comprising the steps of temporarily placing the wavelength selection filter at an arbitrary angle, matching a transmission band of the wavelength selection filter with an ITU grid which is a specific frequency standardized by ITU, fixing the wavelength selection filter, and finely adjusting, at last, an absolute frequency of the transmission band of the wavelength selection filter with the ITU grid.

### EFFECTS OF THE INVENTION

According to the external cavity wavelength tunable laser of the present invention, there can be provided a wavelength tunable laser with high wavelength accuracy which can suppress a shift from the transmission characteristic peak of the wavelength selection filter due to intracavity etalons.

In addition, according to the external cavity wavelength tunable laser of the present invention, the transmission band of the wavelength selection filter can be matched with an ITU grid more easily than by the conventional mounting method, thereby mounting the wavelength selection filter in a short period of time.

### BRIEF DESCRIPTION OF DRAWINGS

FIG. 1 is a schematic view of an external cavity wavelength tunable laser according to the first embodiment;

FIG. 2 is a graph showing a shift from an ITU channel as a function of each finesse;

FIG. 3 is a graph showing the relationship between the finesse of an FP etalon and insertion loss;

FIG. 4 is a flowchart showing an example of an etalon mounting method;

FIG. 5 is a flowchart showing another example of the etalon mounting method;

FIG. 6 is a schematic view showing the incident angle of the FP etalon;

FIG. 7 is a schematic view of a module according to the second embodiment;

FIG. 8 is a sectional view showing the arrangement of a semiconductor optical amplifier having a phase adjustment area;

FIG. 9 is a view showing the shifts of the oscillation wavelength from ITU grids as a function of each oscillation wavelength;

FIG. 10 is a schematic view of a module according to the third embodiment;

FIG. 11 is a schematic view of a module according to the fourth embodiment;

FIG. 12 is a graph showing Fabry-Perot modes and the transmission band of a wavelength selection filter;

FIG. 13 is a schematic view showing a wavelength selection filter deterioration due to intracavity etalons;

FIG. 14 is a flowchart showing a conventional etalon mounting method; and

FIG. 15 is a schematic view of a conventional external cavity wavelength tunable laser.

### BEST MODE FOR CARRYING OUT THE INVENTION

The embodiments of the present invention will be described below.

Note that the following description will describe the embodiments of the present invention, and the present invention is not limited to the following embodiments. In order to clarify the explanation, the following description and drawings are abridged and simplified as needed. Those skilled in the art can easily change, add, and modify the respective elements of the following embodiments within the range of the present invention. In addition, the same reference numerals denote the same elements throughout the drawings, and a repetitive description will be omitted as needed to clarify the explanation.

### First Embodiment

An external cavity wavelength tunable laser according to this embodiment is an external cavity wavelength tunable laser including at least a semiconductor optical amplifier, a reflection means which is placed to face one end face of the semiconductor optical amplifier to form an external cavity, a wavelength selection filter which is placed between the semiconductor optical amplifier and the reflection means and has a periodic transmission characteristic with respect to frequency, and a wavelength tunable filter which selectively transmits light with an arbitrary frequency of the plurality of frequencies selected by the wavelength selection filter.

The external cavity wavelength tunable laser according to this embodiment is characterized in that (a) the reflectance of one end face of the external cavity of the semiconductor optical amplifier is 0.1% at most, and the finesse value obtained by dividing the period of the transmission characteristic of the wavelength selection filter by the half value width of the transmission characteristic is 4 or more and 25 or less, (b) the manufacturing accuracy based on the periodic transmission band of the wavelength selection filter and its period (a free spectral range to be referred to as an “FSR” hereinafter) falls within 1/8,000 of the ITU channel interval used in a system using the wavelength tunable laser, and (c) variations in the FSR of the wavelength selection filter due to refractive index dispersion with respect to wavelength fall within 0.5 GHz at most throughout a wavelength tunable range of 4 THz or more.

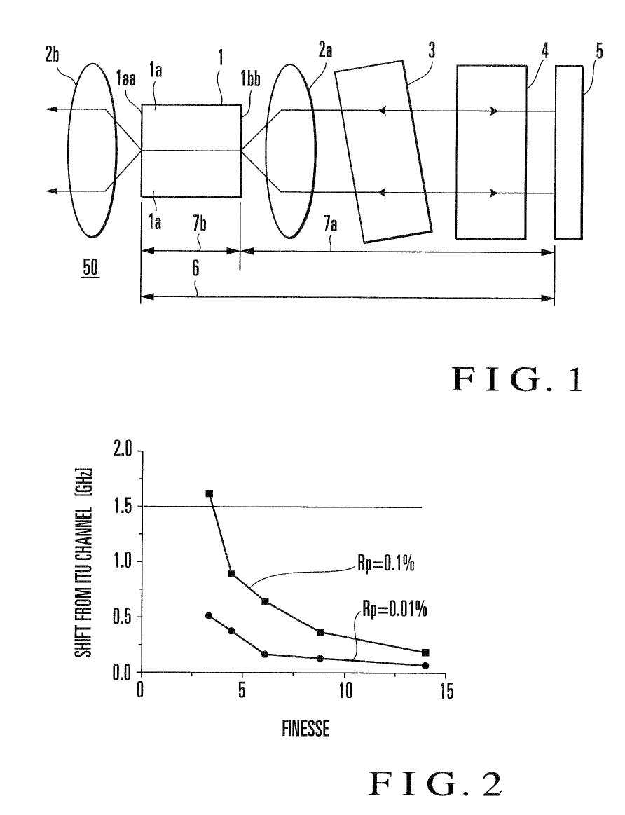

FIG. 1 is a schematic view of an external cavity wavelength tunable laser according to this embodiment.

As shown in FIG. 1, the external cavity wavelength tunable laser comprises a semiconductor optical amplifier 1, collimating lenses 2a and 2b, a wavelength selection filter 3 having a periodic frequency characteristic, a wavelength tunable filter 4, and an external reflection mirror 5.

The reflectance of a cavity side end face 1bb of the semiconductor optical amplifier 1 is reduced to 0.1° or less. The reflectance of an exit side end face 1aa is set to 2% or more to obtain a reflectance that increases the optical power and optimizes the performance in order to function as an output coupler.

The semiconductor optical amplifier 1 is placed between the collimating lenses 2a and 2b. The wavelength selection filter 3 and the wavelength tunable filter 4 are placed between the collimating lens 2a and the external reflection mirror 5.

Note that it is possible to invert the positional relationship between the wavelength selection filter 3 and the wavelength tunable filter 4.

The light generated from the semiconductor optical amplifier 1 upon injection of a current exits from the cavity side end face 1bb of the semiconductor optical amplifier 1 and passes through the collimating lens 2a to be collimated thereby. As a lens suited to this purpose, FLAL0Z101A with a focal length of 0.5 mm is available from ALPS ELECTRIC. However, other lenses can also be used. The parallel light further passes through the wavelength selection filter 3 and the wavelength tunable filter 4. The light with the wavelength selected by the wavelength selection filter 3 and the wavelength tunable filter 4 is reflected by the external reflection mirror 5, passes through the wavelength tunable filter 4, the wavelength selection filter 3, and the collimating lens 2a, and enters the semiconductor optical amplifier 1 via the cavity side end face 1bb of the semiconductor optical amplifier 1 again.

The exit side end face 1aa of the semiconductor optical amplifier 1 is an end face having a finite reflectance of 2% or more. The light which has entered the semiconductor optical amplifier 1 again is reflected by the exit side end face 1aa and is transmitted through the cavity side end face 1bb to exit therefrom. Owing to this one-round feedback effect, only the light with the wavelength selected by the wavelength selection filter 3 and the wavelength tunable filter 4 is amplified in a gain area 1a and oscillated as laser light. That is, the exit side end face 1aa of the semiconductor optical amplifier 1 and the external reflection mirror 5 constitute an external cavity 6.

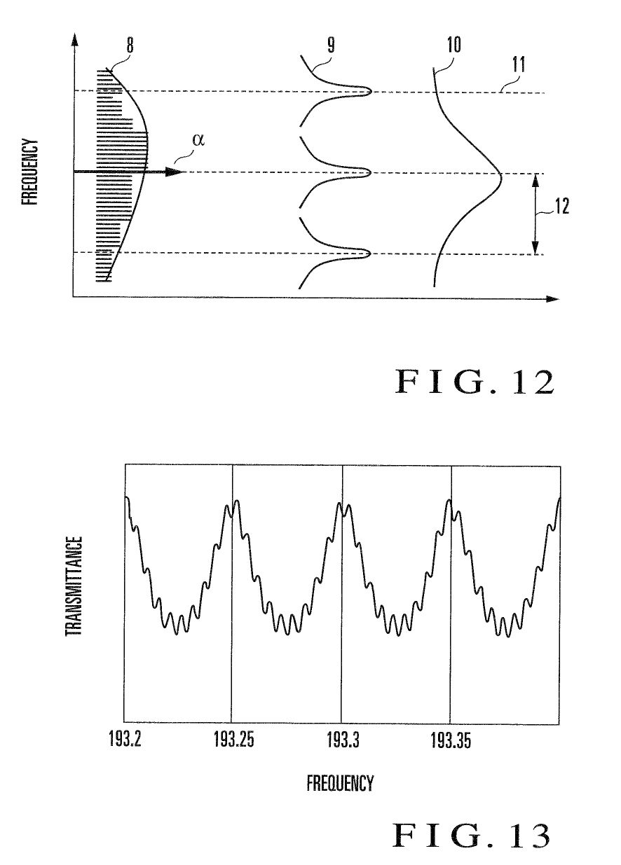

The operation principle of the wavelength selection filter with this arrangement will be described next with reference to FIG. 12.

First of all, light exiting from the gain area 1a contains many Fabry-Perot modes 8 dependent on the length of the external cavity 6. Of these modes, only a plurality of modes which match with the period of the wavelength selection filter 3 (a transmission band 9 of the wavelength selection filter in FIG. 12) are selected and transmitted through the wavelength selection filter 3. The wavelength tunable filter 4 (a transmission band 10 of the wavelength tunable filter in FIG. 12) selects only one of the plurality of modes.

As described above, the external cavity wavelength tunable laser including the wavelength selection filter performs laser oscillation a only in the transmission band of the wavelength selection filter 3, but does not perform laser oscillation a at any intermediate frequency. Therefore, mounting the wavelength selection filter 3 so as to match the transmission band 9 with all desired frequency grids 11 determined by ITU (International Telecommunications Union) or the like within the wavelength tunable range makes it possible to achieve laser oscillation a near the specific frequency (to be referred to as the “ITU grid” hereinafter) 11 standardized by ITU. If an ITU grid interval 12 is 50 GHz, it is necessary to suppress the wavelength accuracy within about ±1.5 GHz. In general, the transmission band of a wavelength selection filter can suppress a shift from the ITU grid within about +0.1 GHz throughout a frequency range of 4 THz.

FIG. 2 shows the relationship between each finesse and a shift from an ITU channel in the above arrangement.

Note that the finesse of the wavelength selection filter 3, e.g., an FP etalon 3a, is determined by the reflectance and an incident angle of an end face of the FP etalon 3a.

FIG. 2 is a graph representing finesses and shifts from the ITU grid with the total external cavity loss caused at the collimating lens 2a, wavelength selection filter 3, wavelength tunable filter 4, and the like being 10 dB. The inspection result obtained by setting a reflectance Rp of the cavity side end face 1bb of the semiconductor optical amplifier 1 to 0.1% and the result obtained by setting the reflectance Rp to 0.01% are also plotted on the same graph.

Referring to FIG. 2, as is obvious, even when the reflectance Rp of the cavity side end face 1bb of the semiconductor optical amplifier 1 is abut 0.1%, a wavelength accuracy of about ±1.5 GHz can be achieved by setting the finesse to 4 or more. In addition, a wavelength accuracy of about ±0.5 GHz can be achieved by setting the finesse to 8 or more.

When the finesse obtained by dividing the FSR of the wavelength selection filter 3 by the half value width of the transmission band 9 of the wavelength selection filter 3 is set to 4 or more, the shift due to the influence of intracavity etalons can be suppressed within about ±1.5 GHz.

The above description is based on the assumption that the ITU grid interval 12 is 50 GHz. However, the same finesse condition can be used for different ITU grid intervals 12 of 100 GHz and 25 GHz. This is because the wavelength accuracy requirement in the wavelength division multiplexing system is equal to or less than a given ratio of the ITU grid interval, and the finesse condition for the wavelength selection filter 3 which is required for the requirement remains unchanged.

It is obvious from FIG. 2 that as the reflectance Rp of the cavity side end face 1bb of the semiconductor optical amplifier 1 decreases, the wavelength accuracy increases. This is because as the influence of the reflectance Rp of the cavity side end face 1bb of the semiconductor optical amplifier 1 decreases, the influence of intracavity etalons decreases, and the wavelength accuracy increases.

It is also important to reduce the total external cavity loss. If the total external cavity loss becomes smaller than 10 dB, the amount of light fed back from the external cavity side increases. As a consequence, the laser optical power increases.

The total external cavity loss is the total of losses at the coupling between the waveguide of the semiconductor optical amplifier 1 and collimated light, the collimating lens 2a, the wavelength selection filter 3, the wavelength tunable filter 4, and the external reflection mirror 5. In particular, the loss at the coupling between the waveguide of the semiconductor optical amplifier 1 and collimated light is 3 dB at maximum, and the loss at the time of transmission of light through the collimating lens 2a is typically 2 dB as the light reciprocates. If the wavelength selection filter 3 is tilted at a maximum angle of 2° from the vertical angle, the loss becomes 2 dB at maximum as the light reciprocates. In order to reduce the total external cavity loss to 10 dB or less, the total of losses at the wavelength tunable filter 4 and the external reflection mirror must be 3 dB or less. If the wavelength tunable filter 4 is of a reflection mirror type, the reflectance must be 50% or more.

If the FP etalon 3a is used as the wavelength selection filter 3, in order to makes it difficult for a beam reflected by the etalon surface from being coupled in the laser cavity, it is necessary to set the angle between a normal line on the etalon surface and the optical axis of the external cavity to 0.10 or more. However, as the finesse of the FP etalon 3a increases, the insertion loss of the FP etalon 3a increases.

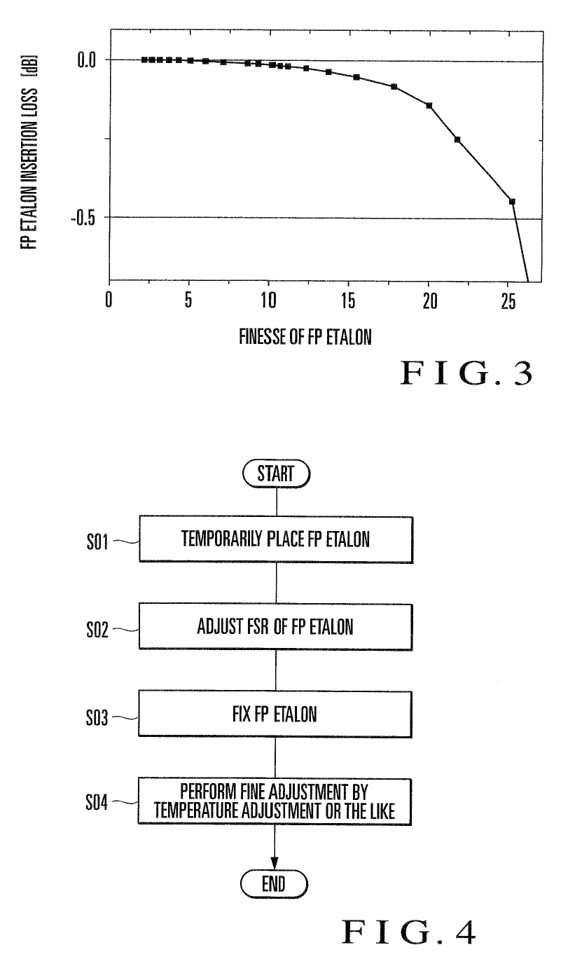

FIG. 3 is a graph showing the result obtained by inspecting the relationship between the finesse of the FP etalon and insertion loss in association with an incident angle of 0.1°.

Referring to FIG. 3, when the finesse is 25 or less, the insertion loss is suppressed to as small as 0.5 dB or less. A finesse of 18 or less is especially preferable because the insertion loss is as small as 0.1 dB or less.

In order to reduce the insertion loss, therefore, it is preferable to set the finesse of the FP etalon to 25 or less.

In order to manufacture an FP etalon with a finesse of 10 or more, however, a high reflectance is required. This makes it difficult to manufacture such an etalon. For this reason, it is preferable to use an FP etalon, as a wavelength selection filter, which has a finesse of 4 or more and 10 or less that can achieve high wavelength accuracy while reducing the insertion loss and facilitates manufacture.

As described above, the reflectance of one end face of the semiconductor optical amplifier is 0.1% at most, and the shift due to the influence of intracavity etalons can be suppressed within about ±1.5 GHz or less by setting the finesse value obtained by dividing the period of the transmission characteristic of the wavelength selection filter by the half value width of the transmission characteristic to 4 or more and 25 or less. This makes it possible to provide a wavelength tunable laser with high wavelength accuracy as an external cavity wavelength tunable laser.

In addition, setting the free spectral range accuracy of the wavelength selection filter to within 1/8,000 of the ITU channel interval used in a system using the wavelength tunable laser makes it possible to easily and quickly mount the wavelength selection filter 3. Using this mounting method can meet the challenge to match the periodic transmission band of the wavelength selection filter with the ITU grid in a wide wavelength range of 4 THz or more when mounting the wavelength selection filter. More specifically, the shift of the transmission band 9 of the wavelength selection filter from the ITU grid 11 can be set to 0.5 GHz or less throughout a frequency range of 4 THz. This can achieve higher wavelength accuracy.

Furthermore, the insertion loss of the wavelength selection filter can be reduced by setting the accuracy in this free spectral range to 1/20,000 or less, thereby facilitating the mounting of the wavelength selection filter.

The method of mounting the wavelength selection filter 3 will be described below with reference to FIG. 4.

This mounting method uses the FP etalon 3a as the wavelength selection filter 3 having a periodic frequency characteristic.

Note that even if another type of filter is used, it is possible to use this mounting method by using a means for adjusting an FSR corresponding to the filter.

Referring to FIG. 4, this process can be divided into “(1) Temporary Placement of FP Etalon”, “(2) Angle Adjustment of FP Etalon”, “(3) Fixation of Etalon”, and “(4) Fine Adjustment by Temperature Adjustment and the Like” as follows.

### (1) Temporary Placement of FP Etalon

First of all, the FP etalon is temporarily placed (step Sol).

An angle θq defined by a normal line on the etalon surface and the axis of the external cavity is set to 0° (vertical incidence condition).

### (2) Adjustment of FSR of FP Etalon

In order to match the FSR of the FP etalon 3a with the ITU channel interval, the peak wavelength of the transmission band is adjusted to match the peak wavelength of the transmission band with the ITU channel (step S02).

Methods of adjusting the FSR of the FP etalon 3a include a method of changing the optical path length by changing the angle of the FP etalon 3a and a method of changing the refractive index or optical path length of the cavity by changing the temperature of the FP etalon. The following description takes as an example the method of adjusting the FSR by changing the angle.

The FSR of the FP etalon 3a can be expressed as follows (c=300,000 km/sec) by using an angle θ, a refractive index n of the FP etalon, an etalon length d, and a light velocity c:

FSR(θ)=c/(2nd×cos θ) (1)

The equation representing the FSR can be rewritten as follows with reference to a case in which the angle defined by a normal line on the surface of the FP etalon 3a and the axis of the external cavity is 0°, i.e., θ=0°:

FSR(θ)=FSR(0)/cos θ (2)

According to the method of adjusting the FSR by changing the angle, the FSR(θ) is minimized when the angle θ is 0, and increases as the angle θ increases. If, therefore, the FSR corresponding to a possible minimum value (θₘᵢₙ) of the angle θ becomes larger than the ITU grid interval, the FSR cannot be matched with the ITU grid interval by angle adjustment.

It is therefore necessary not to exceed the FSR corresponding to the possible minimum angle θ and an FSR(θ minimum) of 50 GHz set in consideration of FSR manufacturing accuracy. It is also necessary to keep the angle of the etalon small and reduce the insertion loss. In general, therefore, the FP etalon 3a with the accuracy represented by equation (3) is used. Note that equation (3) is preferably defined in the center of the oscillation frequency tunable range.

FSR(θₘᵢₙ)=(ITU grid interval)−(FSR manufacturing accuracy)±(FSR manufacturing accuracy) (3)

More specifically, when the FP etalon 3a with an FSR manufacturing accuracy of 0.006 GHz is to be used on the assumption that θₘᵢₙ is 0° and the ITU grid interval 12 is 50 GHz, FSR(0) is 49.994 about ±0.006 GHz, and it is necessary to correct the frequency which is 0.012 GHz at maximum by angle adjustment. When this FSR frequency difference is corrected, the absolute frequencies of the transmission band 9 of the FP etalon greatly change. If the oscillation wavelength is near 193.55 THz (˜4,000×50 GHz) used in a WDM system, the wavelength changes by about 4,000 times the frequency.

That is, this change corresponds to 0.012 GHz×4,000=48 GHz<50 GHz. Since this value is equal to or less than the ITU grid interval 12, the FSR is adjusted by the following simple method:

(i) Attention is given to one ITU grid 11 near the frequency defining equation (3).
(ii) The angle of the FP etalon 3a is changed from 0° to match the transmission band 9 of the FP etalon 3a with the ITU grid 11 of interest.

In this case, the possible angle θq of the etalon becomes 2° or less, and low loss can be achieved. That is, the total insertion loss of the etalon becomes 2 dB or less.

If the ITU grid interval 12 is assumed to be 25 GHz instead of 50 GHz in the above case and an FP etalon with an FSR(0) of 24.997±0.003 GHz is used, an increase in the capacity of wavelength division multiplexing communication can be achieved.

In addition, if the ITU grid interval 12 is assumed to be 100 GHz instead of 50 GHz in the above case and an FP etalon with an FSR(0) of 99.988±0.012 GHz is used, setting the channel interval to be higher than 50 GHz allows the laser to be used for conventional wavelength division multiplexing communication.

### (3) Fixation of Etalon

The FP etalon is then fixed (step S03).

### (4) Fine Adjustment by Temperature Adjustment and The Like

Finally, the ITU grid 11 is matched with an absolute frequency of the transmission band 9 of the FP etalon by finely adjusting the shift between them based on a temperature or the like (step S04).

Since the ITU grid interval 12 is perfectly matched with the FSR of the FP etalon with the above steps, the wavelength accuracy can be suppressed below the shift due to the influence of a wavelength dispersion unique to the material for the FP etalon 3a, and a wavelength accuracy of 0.5 GHz or less can be achieved. That is, the FSR accuracy of the FP etalon is preferably falls within 1/8,000 (50 GHz/about 0.006 GHz) of the ITU channel interval.

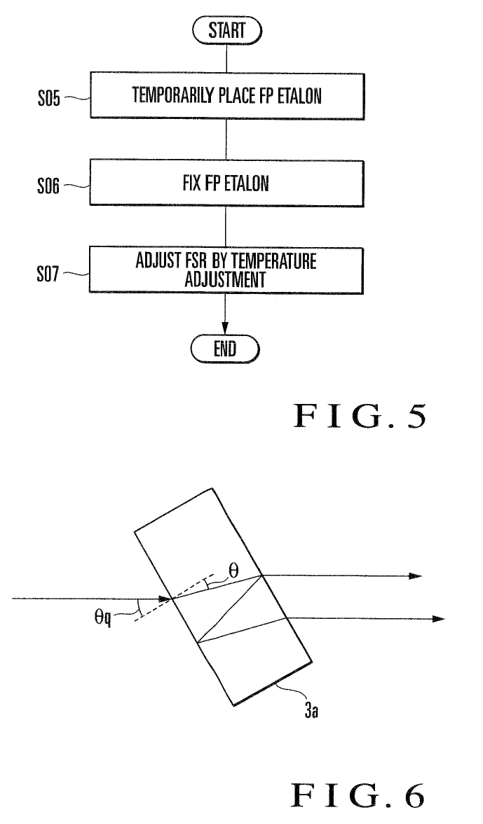

Setting the FSR accuracy of the FP etalon to 1/20,000 of the ITU channel interval allows the etalon to be mounted by only performing temperature adjustment, thereby facilitating the mounting method. A mounting method using an FP etalon with 50 GHz±0.0025 GHz at an etalon angle of 1° will be described below with reference to FIG. 5.

### (1) Temporary Placement of FP Etalon

The angle of the FP etalon is temporarily fixed to 1° (step S05).

### (2) Fixation of FP Etalon

The FP etalon is fixed while the angle in (1) is maintained (step S06).

### (3) FSR Adjustment by Temperature Adjustment

Because of a wavelength accuracy of ±0.0025 GHz, the shift from the ITU grid 11 of the etalon transmission band is 10 GHz (0.0025 GHz×4,000) or less. The temperature characteristic of glass or quartz used for a general FP etalon is 1 GHz/degree, and hence temperature adjustment is performed by ±10° to match the etalon transmission band with the ITU channel (step S07). Since the semiconductor element exhibits no significant difference with a temperature change of ±10°, a satisfactory laser characteristic can be achieved.

That is, performing simple FSR adjustment once can perfectly match the ITU grid interval 12 with the FSR of the FP etalon.

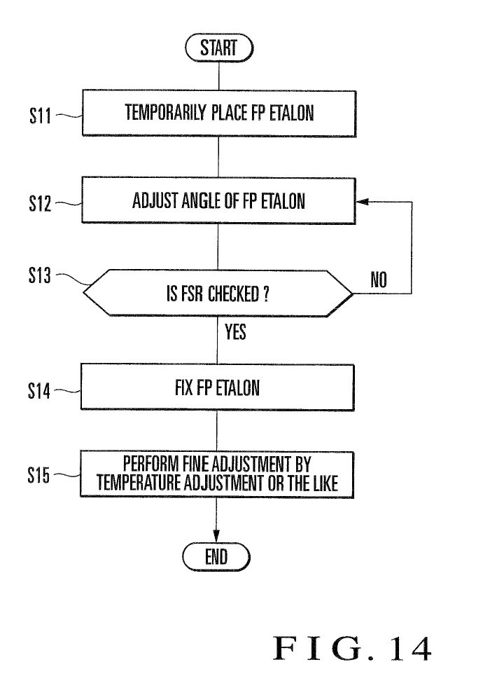

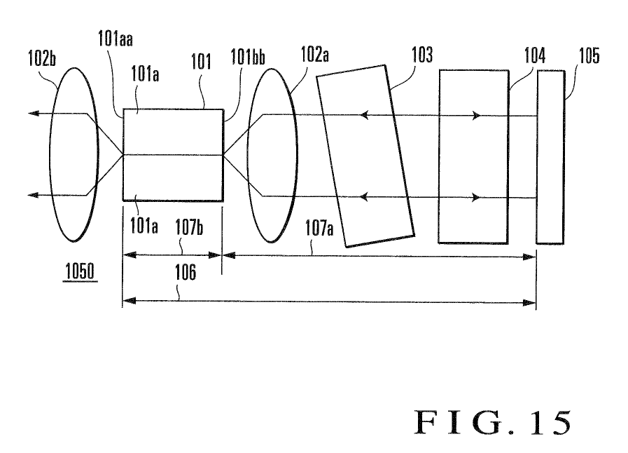

In addition, a low-dispersion material can also be used for an FP etalon. This makes it possible to mount the FP etalon 3a with high wavelength accuracy more easily and quickly than by the conventional mounting method shown in FIG. 14.

It is also conceivable to use, as another mounting method, a method of mounting an FP etalon while checking oscillation wavelength accuracy by actually performing laser oscillation a after mounting the wavelength tunable filter 4 and the external reflection mirror 5 as a reflection means. In this case as well, this method can be implemented by fixing the angle of the FP etalon 3a to the first angle at which the oscillation wavelength matches a channel matching the ITU grid 11.

### Second Embodiment

An external cavity wavelength tunable laser according to this embodiment has the following three characteristic features, in addition to those of the external cavity wavelength tunable laser according to the first embodiment, namely (a) an external cavity incorporates a phase adjustment mechanism, (b) an FP etalon is used as a wavelength selection filter and placed such that the angle defined by a normal line on the etalon surface and the optical axis of light exiting from the semiconductor optical amplifier falls in the range of 0° or more and 2° of less, and (c) a wavelength tunable filter and a reflection means are integrally formed by using a wavelength tunable mirror.

A specific arrangement of the external cavity wavelength tunable laser according to this embodiment will be described below.

The basic arrangement of the external cavity wavelength tunable laser according to this embodiment comprises a semiconductor optical amplifier, collimating lenses, a wavelength selection filter having a periodic frequency characteristic, a wavelength tunable filter, and an external reflection mirror. More specifically, as the wavelength selection filter having a periodic frequency characteristic, a silica-based FP etalon using optical interference can be used. An FP etalon with a finesse of 8 was used in this case. A silica-based FP etalon has great temperature dependency, and its transmission band can be adjusted afterward based on a temperature. The transmission band interval of the FP etalon is determined in accordance with the selection wavelength interval of the wavelength tunable laser, e.g., 25 GHz, 50 GHz, or 100 GHz, which is the ITU grid interval. For example, in order to implement a wavelength tunable laser with an ITU grid interval of 50 GHz, it is preferable to use, as a wavelength selection filter, an FP etalon whose FSR is 49.994 about +0.006 GHz, which is slightly lower than 50 GHz. In this case, the FP etalon is placed such that the angle defined by a normal line on the etalon surface and the optical axis of light exiting from the semiconductor optical amplifier falls within the range of 0° or more and 2° or less.

As a wavelength tunable filter having a wavelength tunable width of 4 THz or more, it is possible to use an acoustooptic filter, a dielectric (multilayer film) filter which changes the refractive index by using heat, an etalon filter which changes the external cavity length by using MEMS (Micro ElectroMechanical Systems), and the like. One of preferable filters is an electrically controlled wavelength tunable mirror having both the function of a wavelength tunable filter and the function of an external reflection mirror. An electrically controlled wavelength tunable mirror is a mirror having a reflection peak at a given wavelength, and the reflection peak wavelength is changed by an applied voltage or applied current, as disclosed in a reference (U.S. Pat. No. 6,215,928B1). Using this electrically controlled wavelength tunable mirror can simplify the arrangement of the laser. The direction perpendicular to the light incident surface of the electrically controlled wavelength tunable mirror preferably falls within about ±1° relative to the incident angle of light. Setting the incident angle of light near the vertical angle can facilitate alignment. In addition, setting the above direction within about ±1° relative to the incident angle of light can prevent an output from the external cavity laser from abruptly decreasing.

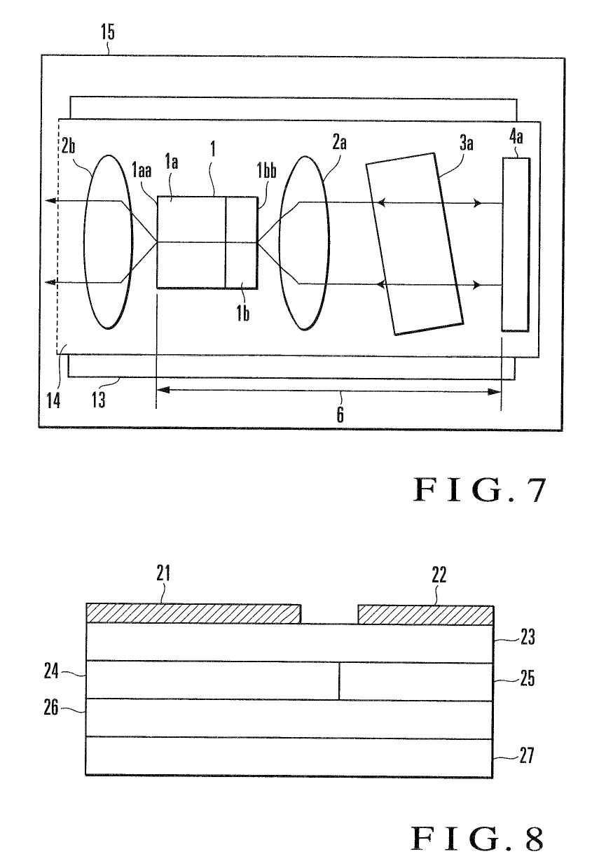

FIG. 7 shows an example of the external cavity wavelength tunable laser with the above specific arrangement.

An exit side end face 1aa of a semiconductor optical amplifier 1 was designed to have a reflectance of 10% in consideration of a driving current for the semiconductor optical amplifier 1 and optical power extracted from a light source. The length of a gain area 1a of the semiconductor optical amplifier 1 was set to 500 μm. According to an external cavity wavelength tunable laser, oscillation with high mode stability can be achieved by performing phase adjustment between the FP modes of the external cavity and the transmission band of the etalon. For this reason, it is preferable to integrate a phase adjustment area in the semiconductor optical amplifier. In this case, a 100-μm phase adjustment area was integrated on the cavity side of the semiconductor optical amplifier. An AR (Anti Reflection) coat was formed on the other end face 1bb (to be referred to as a cavity side end face) to make it have a reflectance of 0.1%.

The semiconductor optical amplifier 1 in which a phase adjustment area 1b is integrated will be described with reference to FIG. 8. FIG. 8 shows an example of the structure of the two-electrode semiconductor optical amplifier 1 having the phase adjustment area 1b. Referring to FIG. 8, the two-electrode semiconductor optical amplifier 1 comprises electrodes 21 and 22 made of gold-alloy thin films or the like, a p-InP clad layer 23, an InGaAsP-based multi quantum well (MQW) active layer 24, a bulk or MQW InGaAsP phase adjustment layer 25 having a band gap larger than that of the MQW active layer 24, an n-InP clad layer 26, and an n-InP substrate 27.

In this case, the MQW active layer 24 can also function as a bulk active layer. When an external cavity laser is manufactured by using this semiconductor amplifier, the refractive index of the InGaAsP phase adjustment layer 25 is changed by controlling an injection current to the electrode 22, thereby finely adjusting the effective cavity length of the external cavity and semiconductor amplifier. This effect allows phase adjustment. The phase adjustment area 1b therefore functions as a phase adjustment mechanism.

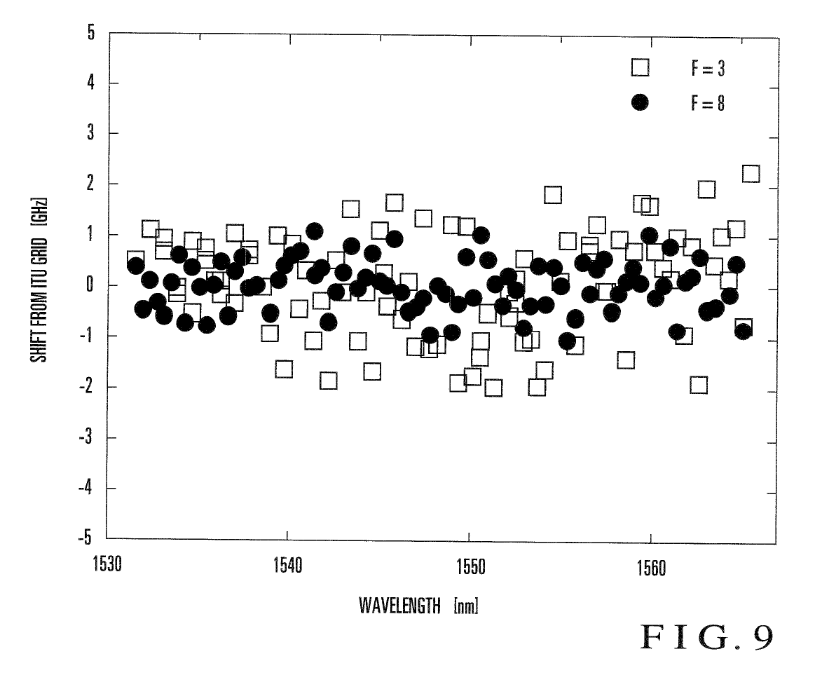

A method of implementing an external cavity wavelength tunable laser will be described next with reference to FIG. 9. First of all, a Peltier element 13 is placed as a temperature controller in a general 14-pin butterfly package 15. One stage 14 made of copper tungsten (CuW) is placed on the Peltier element 13. This stage can be made of silicon, stainless steel, or the like other than CuW. The semiconductor optical amplifier 1 is placed on the CuW stage 14. Collimating lenses 2a and 2b are placed to collimate light from the semiconductor optical amplifier 1. An FP etalon is then placed by the simple implementation method of the present invention such that the transmission band of the FP etalon is matched with the ITU grid. Thereafter, an electrically controlled wavelength tunable mirror 4a is placed.

FIG. 9 is a graph representing the shifts of typical oscillation wavelengths obtained by different ITU grids from the ITU grids in the wavelength tunable laser according to this embodiment, with the abscissa representing wavelength and the ordinate representing the shifts from the ITU grids. For reference, FIG. 9 also shows the result obtained by an etalon with a finesse of 3 which has been used in a conventional wavelength locker or the like. Shifts have occurred almost randomly in the respective channels. This is mainly because of the influence of intracavity etalons. With the conventional FP etalon with a finesse of 3, the wavelength accuracy is about ±2 GHz, which is not satisfactory. In contrast, with the wavelength tunable laser according to this embodiment, a satisfactory wavelength accuracy of about ±1 GHz or less can be obtained. In addition, the side mode suppression ratio (SMSR) was 50 dB or more, which was a satisfactory value.

Stimulated Brillouin scattering is caused by the interaction between incident light and acoustic waves (acoustical vibrations of a crystal grating) passing through a medium in an optical fiber. The optical fiber therefore has the property of being reluctant to transmit optical power with a small line width. It is known that frequency-modulating (FM-modulating) laser light will reduce the influence of the above stimulated Brillouin scattering. According to the present invention, laser light can be FM-modulated by modulating a current value in the phase adjustment area 1b.

At the time of FM modulation, however, the laser oscillation wavelength moves about the transmission peak wavelength of the FP etalon described above. At a wavelength shifted from the transmission peak wavelength, optical loss increases when light is transmitted through the FP etalon. As a result, the cavity loss increases, and the laser optical power value decreases. In optical fiber communication, in general, the power variation which has no influence on the transmission characteristic is 1 dB. In this embodiment, therefore, it is necessary to set the laser optical power variation within 1 dB at a maximum FM modulation degree of ±1 GHz permitted within a wavelength accuracy of about ±1.5 GHz. In order to realize this, the 1-dB transmission bandwidth of the FP etalon needs to be 2 GHz or more. This means that, in consideration of the transmission characteristic of the etalon, 4 GHz or more is required in terms of a 3-dB transmission bandwidth (FWHM).

According to this embodiment, since the external cavity of the external cavity wavelength tunable laser incorporates the phase adjustment mechanism, it is possible to perform transmission band center frequency adjustment for the wavelength selection (tunable) filter and phase adjustment for external cavity modes.

In addition, an FP etalon is used as a wavelength selection filter, and is placed such that the angle defined by a normal line on the etalon surface and the optical axis of light exiting from the semiconductor amplifier falls within the range of 0° or more and 2° or less. This makes it possible to achieve a low insertion loss change and increase the power of the external cavity wavelength tunable laser.

Furthermore, integrally forming a wavelength tunable filter and a reflection means by using a wavelength tunable mirror makes it possible to easily implement a more compact wavelength tunable laser.

### Third Embodiment

An external cavity wavelength tunable laser according to this embodiment has the following two characteristic features, in addition to those of the external cavity wavelength tunable laser according to the first embodiment, namely (a) an external cavity incorporates a phase adjustment mechanism and (b) an FP etalon is used as a wavelength selection filter and placed such that the angle defined by a normal line on the etalon surface and the optical axis of light exiting from the semiconductor amplifier falls in the range of 0° or more and 2° of less.

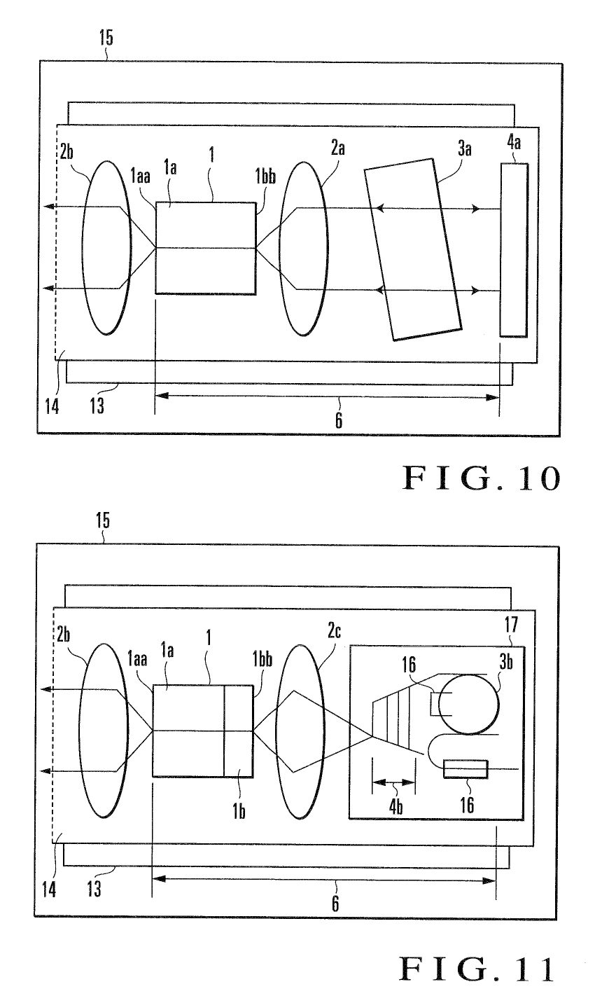

The external cavity wavelength tunable laser according to this embodiment will be described with reference to FIG. 10.

In this external cavity wavelength tunable laser, a semiconductor optical amplifier 1 has a length of 900 μm, the reflectance of an exit side end face 1aa is set to 12% so as to reduce a laser threshold and stabilize operation, and the reflectance of a low-reflectance end face is set to 0.01%. As a wavelength selection filter 3, an FP etalon 3b is used, which has a finesse of 15 and an FSR of 99.988 GHz about +0.012 GHz. This laser also uses an electrically controlled wavelength tunable mirror 4a which can change its transmission band by a wavelength tunable width of 4 THz or more.

A method of implementing the external cavity wavelength tunable laser according to this embodiment is the same as that described in the second embodiment, and hence a repetitive description will be omitted.

In this case, since the temperature characteristic of the FSR of the air-gap FP etalon 3b is as small as 0.1 nm/degree, it is important to almost perfectly match the transmission band of the FP etalon 3b with the ITU grid. In this case, the etalon is placed such that the angle defined by a normal line on the etalon surface and the optical axis of light exiting from the semiconductor amplifier falls in the range of 0° or more and 2° or less.

It is, however, possible to perform phase adjustment for the semiconductor optical amplifier 1 by changing the temperature of a stage 14 using a Peltier element 13 of a temperature controller.

The following is a method of driving the external cavity wavelength tunable laser according to this embodiment.

First of all, a voltage is applied to the electrically controlled wavelength tunable mirror 4a to change the wavelength. Phase adjustment is then performed by adjusting Fabry-Perot modes dependent on the external cavity by temperature control using the Peltier element 13 of the temperature controller in the transmission band of the wavelength selection filter which is selected by the electrically controlled wavelength tunable mirror 4a. This embodiment can obtain a satisfactory wavelength accuracy of about ±0.5 GHz or less.

According to this embodiment, since the external cavity of the external cavity wavelength tunable laser incorporates the phase adjustment mechanism, it is possible to perform transmission band center frequency adjustment of the wavelength selection (tunable) filter and phase adjustment for external cavity modes.

In addition, an FP etalon is used as a wavelength selection filter, and is placed such that the angle defined by a normal line on the etalon surface and the optical axis of light exiting from the semiconductor amplifier falls within the range of more than 0° and less than 2°. This makes it possible to achieve a low insertion loss change and increase the power of the external cavity wavelength tunable laser.

### Fourth Embodiment

An external cavity wavelength tunable laser according to this embodiment has the following three characteristic features, in addition to those of the external cavity wavelength tunable laser according to the first embodiment, namely (a) an external cavity incorporates a phase adjustment mechanism, (b) a wavelength selection filter, wavelength tunable filter, and reflection means are integrally formed by using a ring resonator, and (c) the external cavity comprises a semiconductor optical amplifier and a reflection means having a reflectance of 90% or more.

The external cavity wavelength tunable laser according to this embodiment will be described with reference to FIG. 11.

As a semiconductor optical amplifier 1, for example, an element obtained by integrating, for example, a phase adjustment area 1b having a length of 200 μm as well as a gain area 1a having a length of 800 μm is prepared. One end face of the semiconductor optical amplifier 1 which is located on the gain area 1a side has a reflectance of 5%, and the other end face located on the phase adjustment area 1b side serves as a low-reflectance end face having a reflectance of 0.01%. As a wavelength selection filter, a ring resonator 3b having a finesse of 15 and an FSR of 50 about ±0.002 GHz is used. As a wavelength tunable filter 4, a ladder-type filter 4b which can change its transmission band by a wavelength tunable width of 4 THz or more is mounted on the same substrate on which the ring resonator 3b is mounted. In addition, a phase adjustment area 16 is provided on the ring resonator 3b and part of a waveguide to allow phase adjustment based on current injection. A high-reflectance coat 17 having a reflectance of 90% or more replaces the external mirror.

A method of implementing the external cavity wavelength tunable laser according to this embodiment will be described. First of all, a Peltier element 13 is placed as a temperature controller in a general 14-pin butterfly package 14. One substrate 14 made of copper tungsten (CuW) is placed on the Peltier element 13. The semiconductor optical amplifier 1 is placed on the CuW substrate 14. A lens 2c is then placed to couple light from the semiconductor optical amplifier 1 to an aspherical lens and the wavelength selection filter. In this case, the semiconductor optical amplifier 1 is coupled to a wavelength selection filter 3 by using one lens. However, it suffices to use two or more lenses. In addition, a light output lens 2b is placed.

A method of driving the external cavity wavelength tunable laser according to this embodiment will be described next.

First of all, a voltage/current is applied to the ladder-type filter 4b to change the wavelength. Phase adjustment is performed for the transmission band of the ring resonator 3b which is selected by the ladder-type filter by adjustment based on a phase adjustment current in the semiconductor optical amplifier 1 for Fabry-Perot modes 8 dependent on the external cavity. Although the wavelength selection method is complicated due to the presence of the phase adjustment area outside the semiconductor optical amplifier in this case, a high wavelength accuracy of about ±0.1 GHz can be achieved.

According to this embodiment, since the external cavity of the external cavity wavelength tunable laser incorporates the phase adjustment mechanism, it is possible to perform transmission band center frequency adjustment of the wavelength selection (tunable) filter and phase adjustment for external cavity modes.

Furthermore, integrally forming a wavelength selection filter, a wavelength tunable filter, and a reflection means by using a ring resonator makes it possible to easily implement a more compact wavelength tunable laser. Moreover, since the external cavity comprises the semiconductor optical amplifier and the reflection means having a reflectance of 90% or more, an increase in the power of the wavelength tunable laser can be achieved.

1. An external cavity wavelength tunable laser characterized by comprising:
a semiconductor optical amplifier;
reflection means which is placed to face one end face of said semiconductor optical amplifier to form an external cavity;
a wavelength selection filter which is placed between said semiconductor optical amplifier and said reflection means and has a periodic transmission characteristic with respect to frequency; and
a wavelength tunable filter which selectively transmits light with an arbitrary frequency of a plurality of frequencies selected by said wavelength selection filter,
wherein a reflectance of said one end face of said semiconductor optical amplifier is 0.1% at most, and a finesse value obtained by dividing a period of the transmission characteristic of said wavelength selection filter by a half value width of the transmission characteristic is not less than 4 and not more than 25.

2. An external cavity wavelength tunable laser according to claim 1, characterized in that the finesse of said wavelength selection filter is not more than 10.

3. An external cavity wavelength tunable laser according to claim 1, characterized in that an accuracy of a free spectral range of said wavelength selection filter falls within 1/8,000 of an ITU channel interval used in a system using a wavelength tunable laser.

4. An external cavity wavelength tunable laser according to claim 1, characterized in that an accuracy of a free spectral range of said wavelength selection filter falls within 1/20,000 of an ITU channel interval used in a system using a wavelength tunable laser.

5. An external cavity wavelength tunable laser according to claim 1, characterized in that a free spectral range of said wavelength selection filter is near 50 GHz.

6. An external cavity wavelength tunable laser according to claim 1, characterized in that a free spectral range of said wavelength selection filter is near 25 GHz.

7. An external cavity wavelength tunable laser according to claim 1, characterized in that a free spectral range of said wavelength selection filter is near 100 GHz.

8. An external cavity wavelength tunable laser according to claim 1, characterized by further comprising a mechanism which adjusts a phase in said external cavity.

9. An external cavity wavelength tunable laser according to claim 1, characterized in that said wavelength selection filter has an FSR variation of 0.5 GHz at most due to a refractive index dispersion with respect to wavelength throughout a wavelength tunable range of not less than 4 THz.

10. An external cavity wavelength tunable laser according to claim 9, characterized in that said wavelength selection filter is a Fabry-Perot etalon which is placed such that an angle defined by a normal line on an etalon surface and an optical axis of light exiting from said semiconductor amplifier falls in a range of more than 0° and less than 2°.

11. An external cavity wavelength tunable laser according to claim 9, wherein a half value width of a transmission band of said wavelength selection filter is not less than 4 GHz.

12. An external cavity wavelength tunable laser according to claim 9, characterized in that said wavelength selection filter is a crystal Fabry-Perot etalon.

13. An external cavity wavelength tunable laser according to claim 9, characterized in that said wavelength selection filter is a silica Fabry-Perot etalon.

14. An external cavity wavelength tunable laser according to claim 9, characterized in that said wavelength tunable filter is an acoustooptic filter.

15. An external cavity wavelength tunable laser according to claim 1, characterized in that optical loss in said wavelength tunable filter is not more than 3 dB.

16. An external cavity wavelength tunable laser according to claim 1, characterized in that said wavelength tunable filter and said reflection means comprise a wavelength tunable mirror.

17. An external cavity wavelength tunable laser according to claim 16, characterized in that a reflectance of said wavelength tunable mirror is not less than 50%.

18. An external cavity wavelength tunable laser according to claim 1, characterized in that a reflectance of said reflection means is not less than 90%.

19. An external cavity wavelength tunable laser according to claim 1, characterized in that said wavelength selection filter and, said wavelength tunable filter, comprise a ring resonator filter.

20. An external cavity wavelength tunable laser according to claim 1, characterized in that a reflectance of an end face on an opposite side to said one end face of said semiconductor optical amplifier is between 2% and 12%.

21. A mounting method for a wavelength selection filter in an external cavity wavelength tunable laser including a semiconductor optical amplifier, reflection means which is placed to face one end face of the semiconductor optical amplifier to form an external cavity, a wavelength selection filter which is placed between the semiconductor optical amplifier and the reflection means and has a periodic transmission characteristic with respect to frequency, and a wavelength tunable filter which selectively transmits light with an arbitrary frequency of a plurality of frequencies selected by the wavelength selection filter, wherein a reflectance of one end face of the semiconductor optical amplifier is 0.1% at most, and a finesse value obtained by dividing a period of the transmission characteristic of the wavelength selection filter by a half value width of the transmission characteristic is not less than 4 and not more than 25, characterized by comprising the steps of:
temporarily placing the wavelength selection filter at an arbitrary angle;
matching a transmission band of the wavelength selection filter with an ITU grid which is a specific frequency standardized by ITU;
fixing the wavelength selection filter; and
finely adjusting, at last, an absolute frequency of the transmission band of the wavelength selection filter with the ITU grid.

22. A mounting method for a wavelength selection filter in an external cavity wavelength tunable laser including a semiconductor optical amplifier, reflection means which is placed to face one end face of the semiconductor optical amplifier to form an external cavity, a wavelength selection filter which is placed between the semiconductor optical amplifier and the reflection means and has a periodic transmission characteristic with respect to frequency, and a wavelength tunable filter which selectively transmits light with an arbitrary frequency of a plurality of frequencies selected by the wavelength selection filter, wherein a reflectance of one end face of the semiconductor optical amplifier is 0.1% at most, and a finesse value obtained by dividing a period of the transmission characteristic of the wavelength selection filter by a half value width of the transmission characteristic is not less than 4 and not more than 25, characterized by comprising the steps of:
temporarily placing the wavelength selection filter at an arbitrary angle;
fixing the wavelength selection filter; and
finely adjusting, at last, an absolute frequency of the transmission band of the wavelength selection filter with an ITU grid.
